(19) United States
(12) Patent Application Publication
(10) Pub. No.: US 2026/0222325 A1
(43) Pub. Date: Jul. 30, 2026

(54) FLOW STATISTICS TRANSFER SYSTEM, FLOW STATISTICS TRANSFER METHOD, AND FLOW STATISTICS TRANSFER PROGRAM

(71) Applicant: NTT, Inc., Tokyo (JP)

(72) Inventors: Akinori FURUTA, Musashino-shi, Tokyo (JP); Yuhei HAYASHI, Musashino-shi, Tokyo (JP); Atsushi SUTO, Musashino-shi, Tokyo (JP); Satomi Inoue, Musashino-shi, Tokyo (JP)

(21) Appl. No.: 19/144,127

(22) PCT Filed: Jan. 19, 2023
(86) PCT No.: PCT/JP2023/001555

§ 371 Date: Jun. 27, 2025

(51) Int. Cl. H04L 43/062; H04L 41/142

(52) U.S. Cl. CPC H04L 43/062; H04L 41/142

(57) ABSTRACT

A network monitoring system includes a collection unit and a binarization unit. The collection unit collects flow statistical information. The binarization unit converts the flow statistical information into binary data. Thereafter, the binarization unit transmits the binary data via a transmission path.

### TECHNICAL FIELD

The present disclosure relates to a flow statistical information transmission system, a flow statistical information transmission method, and a flow statistical information transmission program.

### BACKGROUND ART

Telecommunication carriers have obtained flow statistics information (flow statistics) to visualize network traffic. In the visualization of network traffic, an xFlow technique or a packet encapsulation technique is used.

“xFlow” is a generic term used to collectively refer to various network monitoring protocols. Examples of network monitoring protocols include NetFlow, IP Flow Information Export (IPFIX) and sFlow (registered trademark). The xFlow technique is a technique for sampling traffic transmitted over a network, and then aggregating and analyzing traffic. For example, the following operations are performed in NetFlow (RFC3954): (1) sampling packets; (2) deriving flow statistical information from header information; and (3) transmitting the flow statistical information.

A packet encapsulation technique is a technique for embedding a packet in a payload of another packet on a network and then transmitting an encapsulated packet. For example, as the packet encapsulation technique, there is a format conversion technique for retrieving packets from capsules and then enabling analysis of inner packets.

### CITATION LIST

### Patent Literature

[PTL 1] Japanese Patent Application Publication No. 2019-097069
[PTL 2] Japanese Patent Application Publication No. 2021-090161

### Non Patent Literature

[NPL 1] “RFC3954 Cisco Systems NetFlow Services Export Version 9” [online], [retrieved on Jan. 19, 2023], Internet <https://www.rfc-editor.org/rfc/rfc3954>

### SUMMARY OF INVENTION

### Technical Problem

However, in the above-described techniques of the related art, it may be difficult to reduce an amount of transmission data in flow statistical information.

Accordingly, the present disclosure provides a flow statistical information transmission system, a flow statistical information transmission method, and a flow statistical information transmission program capable of reducing an amount of transmission data in flow statistical information.

### Solution to Problem

According to an aspect of the present disclosure, a flow statistical information transmission system includes a collection unit configured to collect flow statistical information, a conversion unit configured to convert the flow statistical information into binary data, and a transmission unit configured to transmit the binary data via a transmission path.

### Advantageous Effects of Invention

The flow statistical information transmission system is capable of reducing an amount of transmission data in the flow statistical information.

### BRIEF DESCRIPTION OF DRAWINGS

FIG. 1 is a diagram illustrating an example of a problem related to transmission of flow statistical information.

FIG. 2 is a block diagram illustrating an example of an environment for the transmission of the flow statistical information.

FIG. 3 is a diagram illustrating an overview of one type of flow statistical information transmission processing according to the present disclosure.

FIG. 4 is a block diagram illustrating an example of a configuration of a network monitoring system according to the present disclosure.

FIG. 5 is a sequence diagram showing an example of processing for transmitting flow statistical information as binary data.

FIG. 6 is a diagram illustrating an example of binarization of the flow statistical information according to the present disclosure.

FIG. 7 is a diagram illustrating an example of Jsonification of binary data according to the present disclosure.

FIG. 8 is a diagram illustrating an example of a hardware configuration of a computer.

### DESCRIPTION OF EMBODIMENTS

A plurality of embodiments of the present disclosure will be described in the appended drawings and in the following description. The present invention is not limited to these embodiments. A plurality of features of various embodiments may be combined in various ways under the conditions that these plurality of features are not contradictory to each other. The same reference signs denote the same elements.

### Contents

The following description consists of nine sections:
1. Introduction
2. Environment for transmission of flow statistical information
3. Overview of flow statistical information transmission processing
4. Configuration of network monitoring system
5. Sequence diagram of flow statistical information transmission processing
6. Effects
7. Hardware configuration
8. Summary of embodiments
9. Supplements

### 1. Introduction

An amount of communication in carrier networks has increased year by year. An amount of data for traffic visualization has also increased. In addition, there is a need to acquire more detailed flow statistical information. Therefore, telecommunication carriers are required to reduce bandwidths.

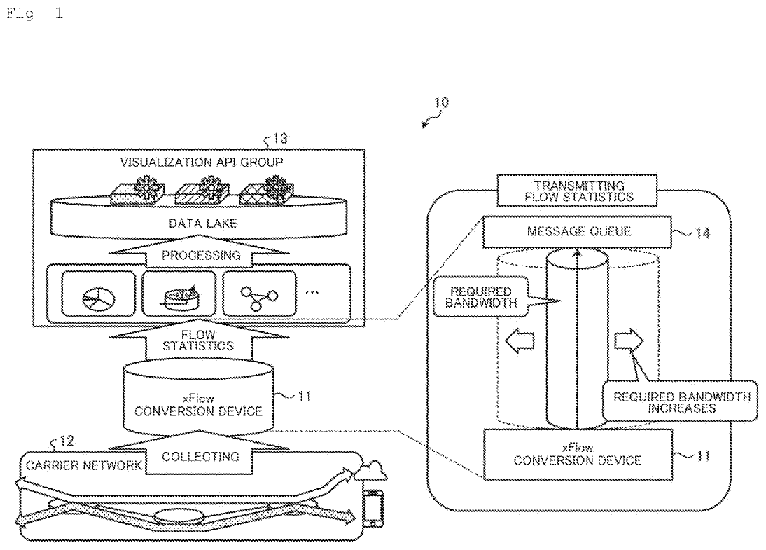

FIG. 1 illustrates a problem 10 which is an example of a problem related to transmission of flow statistical information. The problem 10 is that a required bandwidth increases as a telecommunication carrier acquires more detailed flow statistical information.

As illustrated in FIG. 1, an xFlow conversion device 11 collects header samples and xFlow packets from a carrier network 12. The xFlow conversion device 11 generates flow statistical information based on inside packets. For example, the flow statistical information includes flow information and data related to routing and a topology. The flow statistical information is transmitted to a visualization application programming interface (API) group 13. The visualization API group 13 processes the flow statistical information in order to visualize traffic.

The xFlow conversion device 11 may be implemented by a router. The visualization API group 13 may be implemented by a server.

In order to obtain more detailed flow information, the xFlow conversion device 11 can collect header sample information. Accordingly, the xFlow conversion device 11 can transmit more detailed flow statistical information to the visualization API group 13.

As can be seen from the example of FIG. 1, the xFlow conversion device 11 transmits the flow statistical information via a transmission path between the xFlow conversion device 11 and a message queue 14 of the visualization API group 13. The xFlow conversion device 11 transmits the flow statistical information in Java Script (registered trademark) Object Notation (JSON (that is, in a text format)). However, the JSON data has a large amount of transmission data. Therefore, a bandwidth required for a transmission section increases.

As described above, the required bandwidth increases in accordance with the amount of flow statistical information. In order to solve the above problem, the network monitoring system according to the present disclosure performs one type or a plurality of types of flow statistical information transmission processing to be described below.

### 2. Environment for Transmission of Flow Statistical Information

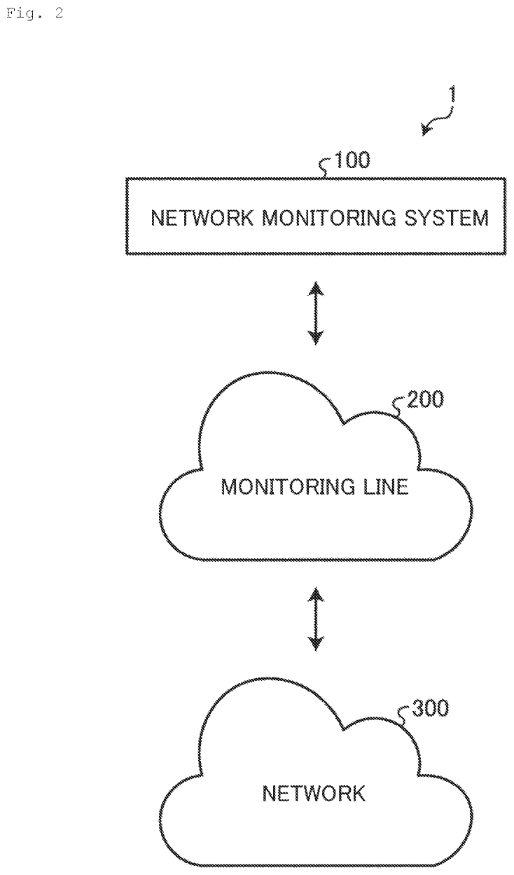

First, an environment for transmission of the flow statistical information will be described with reference to FIG. 2.

FIG. 2 is a block diagram illustrating an environment 1 which is an example of an environment for the transmission of the flow statistical information. As illustrated in FIG. 2, the environment 1 includes a network monitoring system 100, a monitoring line 200, and a network 300. The network monitoring system 100 is an example of a flow statistical information transmission system.

The network monitoring system 100 is a system that performs processing for transmitting the flow statistical information. In this specification, such processing is called flow statistical information transmission processing. An overview of one type of flow statistical information transmission processing will be described in Section 3. The details of the flow statistical information transmission processing will be described with reference to the sequence diagram in Section 5.

The network monitoring system 100 includes one or a plurality of data processing devices such as one or a plurality of servers, one or a plurality of personal computers (PCs), or one or a plurality of network devices. An example of the configuration of the network monitoring system 100 will be described in Section 4.

The monitoring line 200 is, for example, a wide area network (WAN) line, an Internet line, or the like. The monitoring line 200 connects the network monitoring system 100 and the network 300.

The network 300 is a monitoring target network (monitored network). The network 300 is, for example, a network such as a WAN.

### 3. Overview of Flow Statistical Information Transmission Processing

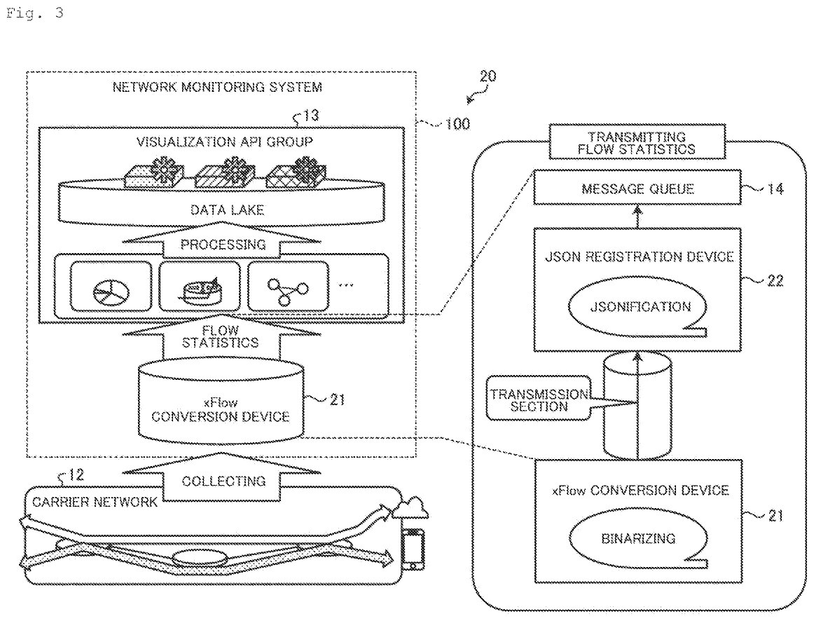

Next, an overview of one type of flow statistical information transmission processing will be described with reference to FIG. 3. The overview is not intended to limit the present invention or a plurality of embodiments to be described in the following sections.

FIG. 3 illustrates an overview 20 that is an overview of one type of flow statistical information transmission processing according to the present disclosure. The overview 20 shows binarization of the flow statistical information and Jsonification of the binary data as new processing.

As illustrated in FIG. 3, the network monitoring system 100 includes an xFlow conversion device 21 and a visualization API group 13. The visualization API group 13 includes a JSON registration device 22.

The xFlow conversion device 21 may have the same function as the xFlow conversion device 11 described above with reference to FIG. 1. The same description of the xFlow conversion device 11 will be omitted here. A function newly added to the xFlow conversion device 21 is the binarization of text data. The xFlow conversion device 21 converts the text data into binary data so that the text data can be subjected to Jsonification.

The JSON registration device 22 is a newly added device. The JSON registration device 22 converts the binary data into data in a JSON format.

In the example illustrated in FIG. 3, the xFlow conversion device 21 reduces an amount of transmission data using binary transmission. The xFlow conversion device 21 transmits the binary data to the JSON registration device 22. The JSON registration device 22 performs Jsonification on the binary data after the binary data passes through a transmission section. The JSON data is transmitted to the message queue 14. In this way, the xFlow conversion device 21 can reduce a bandwidth required for the transmission section.

### 4. Configuration of Network Monitoring System

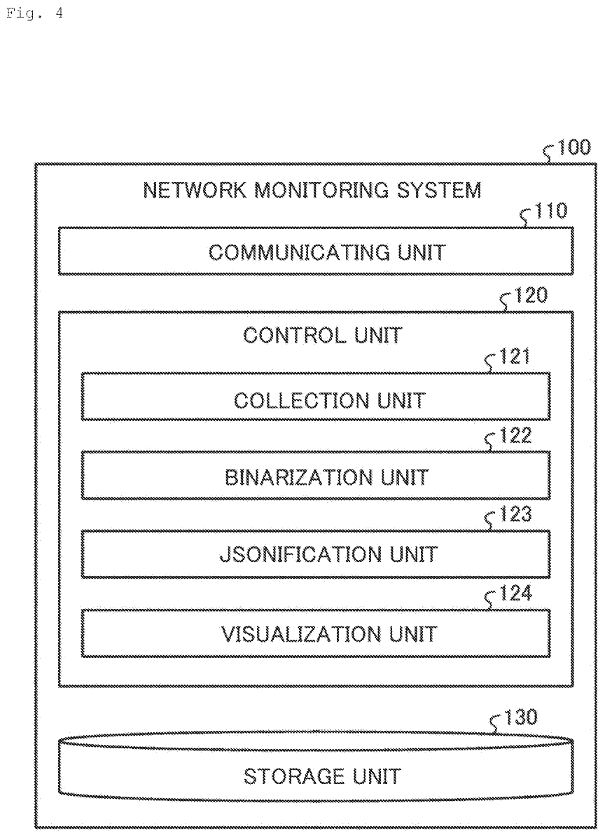

Next, an example of a configuration of the network monitoring system 100 will be described with reference to FIG. 4.

FIG. 4 is a block diagram illustrating an example of a configuration of the network monitoring system 100 according to the present disclosure. As illustrated in FIG. 4, the network monitoring system 100 includes a communication unit 110, a control unit 120, and a storage unit 130. The network monitoring system 100 may include an input unit (for example, a keyboard or a mouse) that receives an input from an administrator of the network monitoring system 100. The network monitoring system 100 may include an output unit (for example, a liquid crystal display or an organic electroluminescence (EL) display) that displays information for the administrator.

### (Communication Unit 110)

The communication unit 110 is implemented by a network device such as a network interface card (NIC), an optical fiber cable L2 (Layer2) switch, an L3 (Layer3) switch, or a router. The communication unit 110 is connected to the monitoring line 200. The communication unit 110 can transmit and receive data to and from the network 300 via the monitoring line 200.

### (Control Unit 120)

The control unit 120 is implemented by any of various programs stored in a data processing device and a storage device. The data processing device is, for example, a processor such as a central processing unit (CPU), a micro processing unit (MPU), or a general purpose graphic processing unit (GPGPU). The control unit 120 may be implemented as a controller that controls a plurality of operations of the network monitoring system 100. For example, when a program (a plurality of instructions) is executed by causing one or a plurality of processors to use a random access memory (RAM) as a work area, one or a plurality of processors perform a plurality of operations.

The control unit 120 can receive input data for flow statistical information transmission processing from an external device. The control unit 120 can store data such as input data, data used in the flow statistical information transmission processing, output data of the flow statistical information transmission processing, and the like in the storage unit 130. The control unit 120 can acquire such data from the storage unit 130 as necessary.

### (Storage Unit 130)

The storage unit 130 is implemented using a RAM, a semiconductor memory such as a flash memory, a magnetic disk such as a hard disk, or an optical disc. The storage unit 130 can store various types of programs and various types of data.

As illustrated in FIG. 4, the control unit 120 includes a collection unit 121, a binarization unit 122, and a Jsonification unit 123, and a visualization unit 124. The binarization unit 122 is an example of a conversion unit, a transmission unit, and an acquisition unit. The Jsonification unit 123 is an example of a reception unit, an inversion conversion unit, and an acquisition unit. Data processing performed by the individual units will be described below.

### (Collection Unit 121)

The collection unit 121 collects flow statistical information from the network 300. The xFlow conversion device 21 described above with reference to FIG. 3 is an example of the collection unit 121. For example, the collection unit 121 has the same function as a flow exporter.

### (Binarization Unit 122)

The binarization unit 122 converts the flow statistical information into binary data. The binarization unit 122 transmits the binary data to the Jsonification unit 123 via a transmission path (for example, a transmission section in FIG. 3). The xFlow conversion device 21 described above with reference to FIG. 3 is an example of the binarization unit 122.

### (Jsonification Unit 123)

The Jsonification unit 123 receives the binary data via the transmission path. The Jsonification unit 123 inversely converts the binary data into the flow statistical information. The JSON registration device 22 described above with reference to FIG. 3 is an example of the Jsonification unit 123. The flow statistical information is transmitted from the Jsonification unit 123 to the visualization unit 124.

### (Visualization Unit 124)

The visualization unit 124 visualizes traffic by using the flow statistical information. The visualization API group 13 described above with reference to FIG. 3 is an example of the visualization unit 124. For example, the visualization unit 124 has the same function as a flow collector.

### 5. Details of Flow Statistical Information Transmission Processing

The overview of one type of the flow statistical information transmission processing has been described above with reference to FIG. 3. The details of the flow statistical information transmission processing will be described with reference to the sequence diagram in this section.

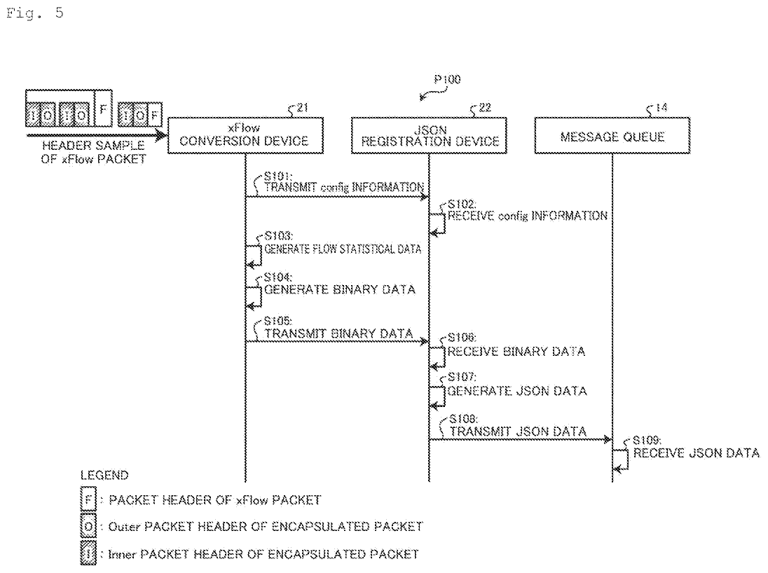

The sequence diagram of an example of the flow statistical information transmission processing will be described with reference to FIG. 5. An example of the flow statistical information transmission processing includes a process of transmitting the flow statistical information as binary data. The processing for transmitting the flow statistical information as binary data is performed by, for example, the xFlow conversion device 21 and the JSON registration device 22 illustrated in FIG. 3. The xFlow conversion device 21 is an example of the binarization unit 122 illustrated in FIG. 4. The JSON registration device 22 is an example of the Jsonification unit 123 illustrated in FIG. 4.

FIG. 5 is a sequence diagram illustrating processing P100 which is an example of processing for transmitting the flow statistical information as binary data. The xFlow conversion device 21 collects header samples and xFlow packets from the network 300 before the start of the processing P100. The xFlow conversion device 21 extracts inner packets from the encapsulated packets.

The xFlow conversion device 21 transmits the config information to the JSON registration device 22 (step S101). The config information is stored in the xFlow conversion device 21.

The JSON registration device 22 receives the config information (step S102). The JSON registration device 22 reads the config information. The config information is copied from the xFlow conversion device 21 to the JSON registration device 22.

The xFlow conversion device 21 generates flow statistical data in a JSON format based on the inside packets (step S103).

The xFlow conversion device 21 generates binary data using the data extracted from the flow statistical data (step S104).

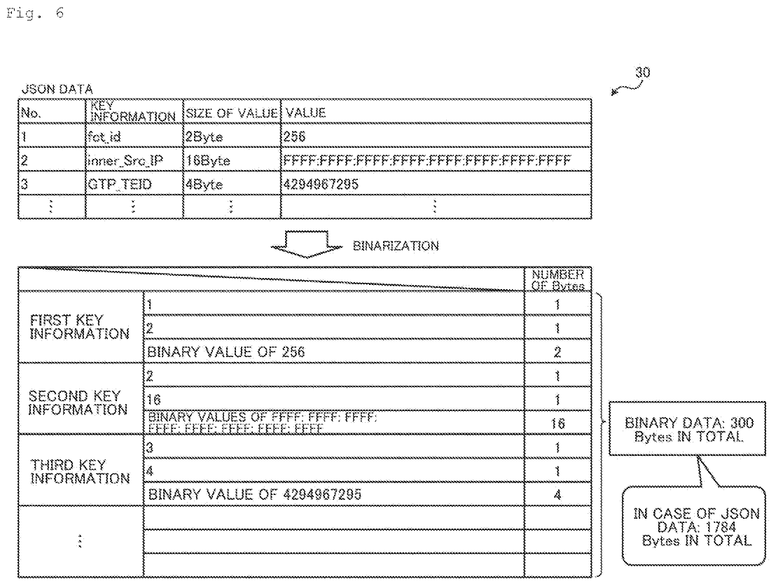

FIG. 6 illustrates binarization 30 which is an example of binarization of the flow statistical information according to the present disclosure. The binarization 30 indicates a data configuration in processing for binarizing the flow statistical data. The flow statistical data is JSON data.

The xFlow conversion device 21 acquires KEY information from the JSON data. The KEY information includes a plurality of keys. The key is also referred to as a variable name (name). The xFlow conversion device 21 also acquires other data associated with the keys.

The xFlow conversion device 21 binarizes the JSON data. In the example illustrated in FIG. 6, a key “fct_id” is replaced with a binary value “1” based on the config information. Similarly, a size of the value “2 bytes” is replaced by a binary value “2” and the value “256” is replaced by a binary value of 256. The KEY information and other data are transmitted from the xFlow conversion device 21 to the JSON registration device 22 by using the config information.

As illustrated in FIG. 6, a plurality of keys such as fct_id, inner_Src_IP and GTP_TEID are replaced with binary values of 1, 2 and 3. Typically, about 50 keys are included in the JSON data. For example, when the JSON data is transmitted using hypertext transfer protocol (HTTP), the amount of transmission data is 1784 bytes in total. Conversely, when the JSON data is converted into binary data, the amount of transmission data is 300 bytes in total. The xFlow conversion device 21 can greatly compress the amount of transmission data by simplifying the KEY information.

Referring back to FIG. 5, the xFlow conversion device 21 transmits the binary data to the JSON registration device 22 (step S105).

The JSON registration device 22 receives the binary data (step S106).

The JSON registration device 22 generates the JSON data using a combination of the binary data and the config information (step S107).

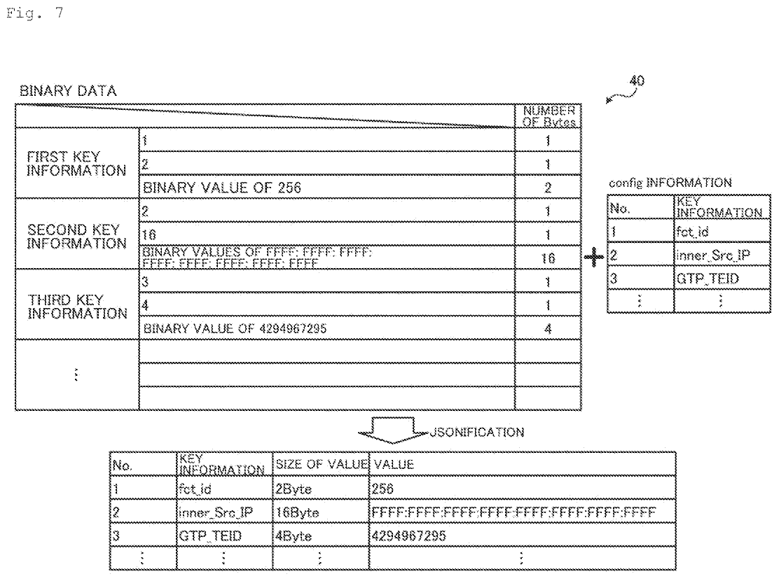

FIG. 7 illustrates Jsonification 40 which is an example of Jsonification of binary data according to the present disclosure. The Jsonification 40 indicates a data configuration in processing for performing Jsonification on the binary data. The JSON registration device 22 generates the JSON data by combining the binary data with the config information.

As illustrated in FIG. 7, the JSON registration device 22 reads the config information, and then generates the JSON data based on the binary data. For example, the binary value “1” is replaced by the key “fct_id”. Similarly, the binary value “2” is replaced by “2 bytes” and the binary value of 256 is replaced by the value of “256”.

Referring back to FIG. 5, the JSON registration device 22 transmits the JSON data to the message queue 14 (step S108).

The message queue 14 receives the JSON data (step S109).

### 6. Effects

The xFlow conversion device 21 can greatly reduce an amount of transmission data by transmitting binary data before the JSON data is generated. As a result, the bandwidth required for a transmission section is greatly reduced.

### 7. Hardware Configuration

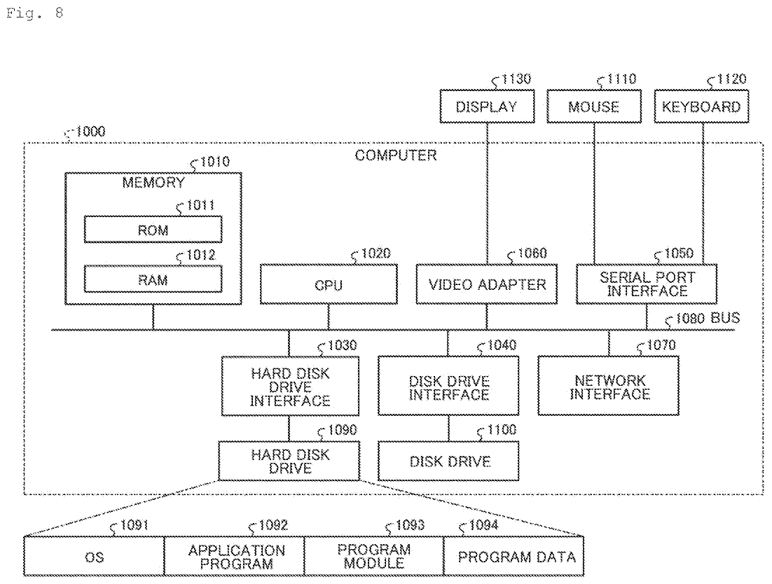

FIG. 8 is a diagram illustrating a computer 1000 which is an example of a hardware configuration of a computer. The system and methods described in the specification are implemented by, for example, the computer 1000.

The computer 1000 is an example of a computer in which the network monitoring system 100 is realized by the execution of a program. The computer 1000 includes a memory 1010 and a CPU 1020. The computer 1000 includes a hard disk drive interface 1030, a disk drive interface 1040, a serial port interface 1050, a video adapter 1060, and a network interface 1070, These constituent elements are connected by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. A removable storage medium (for example, a magnetic disk or an optical disc) may be inserted into the disk drive 1100, The serial port interface 1050 is connected to, for example, a mouse 1110 and a keyboard 1120. The video adapter 1060 is connected to, for example, a display 1130.

The hard disk drive 1090 stores an OS 1091, an application program 1092, a program module 1093, and program data 1094. A program that is executed by the computer 1000 defines a plurality of operations of the network monitoring system 100. This program may be implemented as the program module 1093 written in codes that can be executed by the computer 1000. The program module 1093 is stored in, for example, the hard disk drive 1090. For example, the hard disk drive 1090 stores the program module 1093 that executes the same processing as functions of the constituent elements of the network monitoring system 100. The hard disk drive 1090 may be replaced with a solid state drive (SSD).

The hard disk drive 1090 can store a flow statistical information transmission program for flow statistical information transmission processing. The hard disk drive 1090 may store a computer program product including the flow statistical information transmission program (a plurality of instructions). The flow statistical information transmission program executes one or a plurality of methods, as described above, when the flow statistical information transmission program is executed.

Setting data used for the various types of processing described above may be implemented as the program data 1094. The setting data is stored, for example, in the memory 1010 or the hard disk drive 1090. The CPU 1020 loads the program module 1093 and the program data 1094 stored in the memory 1010 or the hard disk drive 1090 onto the RAM 1012 as necessary. The CPU 1020 performs the various types of processing described above.

The program module 1093 and the program data 1094 may be stored not in the hard disk drive 1090 but a removable storage medium. The CPU 1020 may load the program module 1093 and the program data 1094 via the disk drive 1100 or the like. Alternatively, the program module 1093 and the program data 1094 may be stored in another computer connected to the computer 1000 via a network (LAN, WAN, or the like). In this case, the CPU 1020 may load the program module 1093 and the program data 1094 via the network interface 1070.

### 8. Summary of Embodiments

As described above, the network monitoring system 100 includes the collection unit 121 and the binarization unit 122. In at least one embodiment, the collection unit 121 collects flow statistical information. In at least one embodiment, the binarization unit 122 converts the flow statistical information into binary data. Thereafter, the binarization unit 122 transmits the binary data via the transmission path.

As described above, the network monitoring system 100 includes the Jsonification unit 123. In at least one embodiment, the Jsonification unit 123 receives binary data via a transmission path. Thereafter, the Jsonification unit 123 inversely converts the binary data into flow statistical information.

In some embodiments, the flow statistical information has a JSON format.

In some embodiments, the binarization unit 122 and the Jsonification unit 123 acquire configuration information for designating mapping between a plurality of keys of flow statistical information in the JSON format and a plurality of predetermined binary values. The configuration information is, for example, the config information described above with reference to FIG. 7.

In some embodiments, the binarization unit 122 replaces a plurality of keys of the flow statistical information with a plurality of predetermined binary values based on the configuration information. In other words, the conversion of the flow statistical information into the binary data can include replacing a plurality of keys of the flow statistical information with a plurality of predetermined binary values based on the configuration information.

In some embodiments, the Jsonification unit 123 replaces a plurality of predetermined binary values with the plurality of keys of the flow statistical information based on the configuration information. In other words, the inverse conversion of the binary data into the flow statistical information can include replacing a plurality of predetermined binary values with a plurality of keys of the flow statistical information based on the configuration information.

In some embodiments, the binarization unit 122 replaces a plurality of key values associated with a plurality of keys with a plurality of binary values corresponding to the plurality of key values. In other words, the conversion of the flow statistical information into the binary data may include replacing a plurality of key values associated with the plurality of keys with a plurality of binary values corresponding to the plurality of key values. In some embodiments, the Jsonification unit 123 replaces these binary values with a plurality of key values. In other words, the inverse conversion of the binary data into the flow statistical information may include replacing the binary values with a plurality of key values.

### 9. Supplement

Finally, the above description is supplemented by other embodiments, Various embodiments have been described above with reference to the drawings. The embodiments are exemplary and the above description is not intended to limit the present disclosure to these embodiments. The features described in this specification may be implemented in various ways, including modifications and improvements that are based on the knowledge of those skilled in the art.

### VARIOUS MODIFICATIONS

In this specification, several types of processing have been described as processing automatically performed. Some of these types of processing may be performed manually, Some of the other processing have also been described as processing manually performed. Some or all of other types of processing described above may be performed automatically according to known methods.

Various implementations of the network monitoring system 100 are described herein or illustrated in the drawings. Some implementations relate to information including various types of data, data processing procedures, specific names, or parameters, Such implementations may be optionally modified unless otherwise mentioned. For example, various types of data are not limited to the data illustrated in the drawings.

The constituent elements of the system are illustrated in the drawings. The illustrated constituent elements conceptually illustrate the functions of the system and the device. The constituent elements are not necessarily physically configured as illustrated in the drawings. The constituent elements may be integrated or distributed, and a specific forms of the system and the device are not limited to the illustrated forms. Some or all of the system and the device may be functionally or physically distributed or integrated depending on various loads and usage situations.

### (Terms Indicating Constituent Elements)

The terms such as units (modules, sections, -er suffixes or -or suffixes) can be read as units, means, circuits, and the like. For example, the communication modules, the control modules, and the storage modules include can be read as communication units, control units, and storage units.

### (Configuration of Control Unit)

The configuration of the control unit 120 illustrated in FIG. 4 is exemplary, and the data processing described for specific units does not necessarily have to be performed by the specific units. For example, the binarization unit 122 may perform the data processing described for the collection unit 121. The control unit 120 may include other units not illustrated in FIG. 4. The other units may perform the data processing described with respect to the control unit 120.

### (Data Processing Device)

The data processing device described for the control unit 120 is not limited to the specific hardware described above. The data processing device may be, for example, any of various computers or integrated circuits such as an application specific integrated circuit (ASIC), a field programmable gate array (FPGA), and a general purpose graphic processing unit (GPGPU).

### REFERENCE SIGNS LIST

1 Environment
100 Network monitoring system
110 Communication unit
120 Control unit
121 Collection unit
122 Binarization unit
123 Jsonification unit
124 Visualization unit
130 Storage unit
200 Monitoring line
300 Network

1. A flow statistical information transmission system comprising:
a collection unit, including one or more processors, configured to collect flow statistical information;
a conversion unit, including one or more processors, configured to convert the flow statistical information into binary data; and
a transmission unit, including one or more processors, configured to transmit the binary data via a transmission path.

2. The flow statistical information transmission system according to claim 1, further comprising:
a reception unit, including one or more processors, configured to receive the binary data via the transmission path; and
an inverse conversion unit, including one or more processors, configured to inversely convert the binary data into the flow statistical information.

3. The flow statistical information transmission system according to claim 2,
wherein the flow statistical information has a JavaScript Object Notation (JSON) format.

4. The flow statistical information transmission system according to claim 3, further comprising:
an acquisition unit, including one or more processors, configured to acquire configuration information for designating mapping between a plurality of keys of the flow statistical information in the JSON format and a plurality of predetermined binary values.

5. The flow statistical information transmission system according to claim 4,
wherein the conversion unit is configured to replace the plurality of keys of the flow statistical information with the plurality of predetermined binary values, respectively, based on the configuration information, and
wherein the inverse conversion unit is configured to replace the plurality of predetermined binary values with the plurality of keys of the flow statistical information, respectively, based on the configuration information.

6. The flow statistical information transmission system according to claim 4,
wherein the conversion unit is configured to replace a plurality of key values associated with the plurality of keys with a plurality of binary values corresponding to the plurality of key values, and
wherein the inverse conversion unit is configured to replace the plurality of binary values with the plurality of key values.

7. A flow statistical information transmission method executed by a computer, the method including:
collecting flow statistical information;
converting the flow statistical information into binary data; and
transmitting the binary data via a transmission path.

8. A non-transitory computer-readable storage medium storing a flow statistical information transmission program causing a computer to perform operations comprising:
collecting flow statistical information;
converting the flow statistical information into binary data; and
transmitting the binary data via a transmission path.

9. The non-transitory computer-readable storage medium according to claim 8,
wherein the operations further comprise:
receiving the binary data via the transmission path; and
inversely converting the binary data into the flow statistical information.

10. The non-transitory computer-readable storage medium according to claim 9, wherein the flow statistical information has a JavaScript Object Notation (JSON) format.

11. The non-transitory computer-readable storage medium according to claim 10, wherein the operations further comprise:
acquiring configuration information for designating mapping between a plurality of keys of the flow statistical information in the JSON format and a plurality of predetermined binary values.

12. The non-transitory computer-readable storage medium according to claim 11, wherein the operations further comprise:
replacing the plurality of keys of the flow statistical information with the plurality of predetermined binary values, respectively, based on the configuration information; and
replacing the plurality of predetermined binary values with the plurality of keys of the flow statistical information, respectively, based on the configuration information.

13. The non-transitory computer-readable storage medium according to claim 11, wherein the operations further comprise:
replacing a plurality of key values associated with the plurality of keys with a plurality of binary values corresponding to the plurality of key values; and
replacing the plurality of binary values with the plurality of key values.

14. The flow statistical information transmission method according to claim 7, further comprising:
receiving the binary data via the transmission path; and
inversely converting the binary data into the flow statistical information.

15. The flow statistical information transmission method according to claim 14, wherein the flow statistical information has a JavaScript Object Notation (JSON) format.

16. The flow statistical information transmission method according to claim 15, further comprising:
acquiring configuration information for designating mapping between a plurality of keys of the flow statistical information in the JSON format and a plurality of predetermined binary values.

17. The flow statistical information transmission method according to claim 16, further comprising:
replacing the plurality of keys of the flow statistical information with the plurality of predetermined binary values, respectively, based on the configuration information; and
replacing the plurality of predetermined binary values with the plurality of keys of the flow statistical information, respectively, based on the configuration information.

18. The flow statistical information transmission method according to claim 16, further comprising:
replacing a plurality of key values associated with the plurality of keys with a plurality of binary values corresponding to the plurality of key values; and
replacing the plurality of binary values with the plurality of key values.
